(19) United States
(12) Patent Application Publication
(10) Pub. No.: US 2008/0163052 A1
(43) Pub. Date: Jul. 3, 2008

(54) METHOD AND SYSTEM FOR MULTI-MODAL FUSION OF PHYSICAL AND VIRTUAL INFORMATION CHANNELS

(75) Inventors: David A. George, Somers, NY (US); Raymond R. Hitney, Buchanan, NY (US); Raymond B. Jennings, Ossining, NY (US); Malgorzata E. Stys, Purdys, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,013

(22) Filed: Jan. 2, 2007

(51) Int. Cl. G06F 3/00; G06F 17/00; G06F 3/01

(52) U.S. Cl. 715/702; 345/418; 715/700; 715/705

(57) ABSTRACT

A method and system for multi-modal fusion of physical and virtual information channels is provided. The method and system include a virtual information channel and physical information channel. The method and system also provide for tracking virtual events and physical events corresponding to the virtual event and altering delivery of virtual space content via the virtual information channel upon determining the tracked at least one virtual event meets predetermined criteria.

### CROSS-REFERENCE TO RELATED APPLICATIONS

This application contains subject matter which is related to the subject matter of the following co-pending applications, each of which is assigned to the same assignee as this application, International Business Machines Corporation of Armonk, N.Y. Each of the below listed applications is hereby incorporated herein by reference in its entirety: “Method And System For Dynamic Adapatbility Of Content And Channels”, Docket YOR820060181; and “Method And System For In-Context Assembly Of Interactive Actionable Insights And Modalities In Physical Spaces” Docket YOR820060183.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates generally to providing a dynamic presentation system in a virtual and physical environment for interactive use.

2. Description of the Related Art

Many commercial “kiosk” systems provide a similar means of delivering information in the manner similar to a user's (audience) interaction with Web-like content, such as selecting information content, using a touch screen, keyboard, mouse, or similar choices from physical devices. This is regarded as a virtual space. A physical space includes the content of those devices to deploy the virtual space and additional physical display, interactive and demonstration devices. These can include sight, sound, smell and touch modes for human interaction. However, there is a need in the art to infer something about the audience or user to effectively deliver dynamic content in a manner that suits the audience's or user's profiled needs. Furthermore, there exists a need in the art to provide a multi-modal combination of physical and virtual content delivery to enhance the user experience.

In addition, to maximize the information impact as it applies to providing an elaborate display of content, using system beyond a single multi-modal assembly of virtual and physical content provisioning, there is a need in the art for a method and system for providing a simplified and efficient means to navigate the provided information channels to help ensure the audience obtains satisfactory results in minimum time; and that the results align with business ontologies.

There is also need in the art to teach the methodology for providing the means to assemble interactive and actionable insights between a plurality of multi-modal systems that provide an exceptional experience for the user as each such content-providing “stage” is visited by the user.

Furthermore, there is a need to define a method for guiding the user from any “stage” to other “stages” while, at the same time, maintaining an inter-stage awareness of the particular user, adapting the content and delivery in a manner appropriated to the user.

### SUMMARY OF THE INVENTION

In one embodiment, the present invention is a method and system for dynamic adaptability of content and channels. Embodiments of the present invention enable the interactive user to obtain content in a manner consistent with the learned need of the user and delivered in channels appropriate to the user. Content is defined as the message or information that is imparted to a user or visitor to the system of the invention. Channels are the means for delivering content. Typically, channels include a computer display screen, loud speakers and similar adaptations that convey the intended media or message to the user. Channels include the means for a user to interact with the system of the invention. This is accomplished by receiving user input via standard devices such as a keyboard or touch screen in the normal modality of a computer screen (a “virtual space”) and user information collected though proximity sensing, business card reading, and multi-mode cues from the physical space, including voice and image identification or recognition. Additional cues are obtained from the prior interactions.

In accordance with one embodiment of the present invention a method for multi-modal fusion of a physical information channel and a virtual information channel is provided. The method includes providing a virtual information channel and physical information channel. The method also provides for tracking virtual events and physical events corresponding to the virtual event and altering delivery of virtual space content via the virtual information channel upon determining the tracked at least one virtual event meets predetermined criteria.

The invention is also directed towards a system for multi-modal fusion of physical information and virtual information. The multi-modal system includes a reconfigurable virtual display for displaying the virtual information and input devices connectable to the processor for receiving the physical information. The system also includes output devices for providing output physical information and a processor connected to the reconfigurable display. The processor is adaptable to tracking physical and corresponding virtual events and reconfiguring the reconfigurable virtual display according to the physical information and altering the output physical information.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which improves multi-modal fusion of physical and virtual information channels.

A program storage device readable by a machine, tangibly embodying a program of instructions executable by the machine to perform a method for multi-modal fusion of a physical information channel and a virtual information channel is provided. The method provides a virtual information channel and a physical information channel. The method also includes tracking a virtual event and physical event corresponding to the virtual event. The method alters delivery of the virtual space content upon determining the tracked virtual event meets predetermined criteria. Altering delivery of the virtual space content includes altering delivery of the virtual space content. The method also includes altering navigational guidance upon determining the tracked virtual event meets predetermined criteria. The method further includes altering navigational guidance upon determining the tracked physical event meets predetermined criteria. Altering navigational guidance includes providing navigational guidance selected from the group consisting of providing audio guidance via the at least one physical information channel, providing visual guidance via the at least one physical information channel, and providing tactile guidance via the at least one physical information channel. The method further includes determining if the virtual information channel requires predetermined feedback information from the virtual information channel and adjusting the physical information channel based upon received feedback information.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1 and 1A show a diagram of a physical presentation environment including features of the present invention such as an interactive touch panel display, and items of support and enhancement for operation in a virtual space and the nearby physical space;

FIGS. 2 and 2A are diagrams depicting the selection for content via application of revolving Sprites in accordance with the invention shown in FIG. 1;

FIGS. 3 and 3A depict the information content hierarchy as it relates to that organization, shown as a connected tree graph that is associated with Sprites in accordance with the invention shown in FIG. 1;

FIG. 4 illustrates the result of a user activation of a selection that launches a presentation show on the display in accordance with the invention shown in FIG. 1;

FIG. 5 illustrates the consequence of a typical user activation of selection that launches a movie clip on the display in accordance with the invention shown in FIG. 1;

FIG. 6 shows the alteration of the content due to feedback in the physical environment in accordance with the invention shown in FIG. 1;

FIG. 7 depicts the logical operation of the virtual environment in accordance with the invention shown in FIG. 1;

FIG. 8 depicts the logical operation of the fusion of the multi-modal environment of the virtual and physical space in accordance with the invention shown in FIG. 1; and

FIG. 9 shows the assembly of at least two independent multi-modal (i.e., virtual and physical devices) environments that guide (visitors) users from one to another, also, describing the learned modalities and actionable insights learned about the user “in-time” for effecting appropriate setup on the destination independent display environment.

### DETAILED DESCRIPTION OF THE INVENTION

As described herein, one embodiment of the present invention includes an active user presentation system. This embodiment describes a system for displaying data in a virtual space, including media presentations, video clips, photos, sound and other appealing media in an “in-motion”, revolving display that provides selectable sprites and with at least one physical device that enhances and guides the user's progress in obtaining content.

In the virtual environment as sprites past one or more areas in a repeating circular pattern, additional information is presented for passive identification of content that lies deeper within the hierarchy of information presented to aid the user in making informed selection decisions.

The rotating display provides eye-catching animation and improves accessibility, particularly in a large floorshow setting where the viewer might not be able to reach all points of the display area.

Additionally, methods for adapting the display to factors such as user proximity, interaction history and provided input (such as scanning in the user's business card) are taught.

The organization of the display provides a natural alignment with various business ontologies and provides a method for keeping the user on-track. In addition, features of the present invention provide for tracking user and group interaction experience.

Independent displays, consisting of guiding lighting and other physical devices provide a sensational element of real physical space interaction for the user that intensifies the experience in a tactile way. These can include, but are not limited to, motorized and interlinked mechanical devices, transducers for producing heat, sound, light, fog/mist, vibration, illuminated footprints, and changes to elevation of articles and any similar mode that can both capture the fascination of the user (audience) and deliver information.

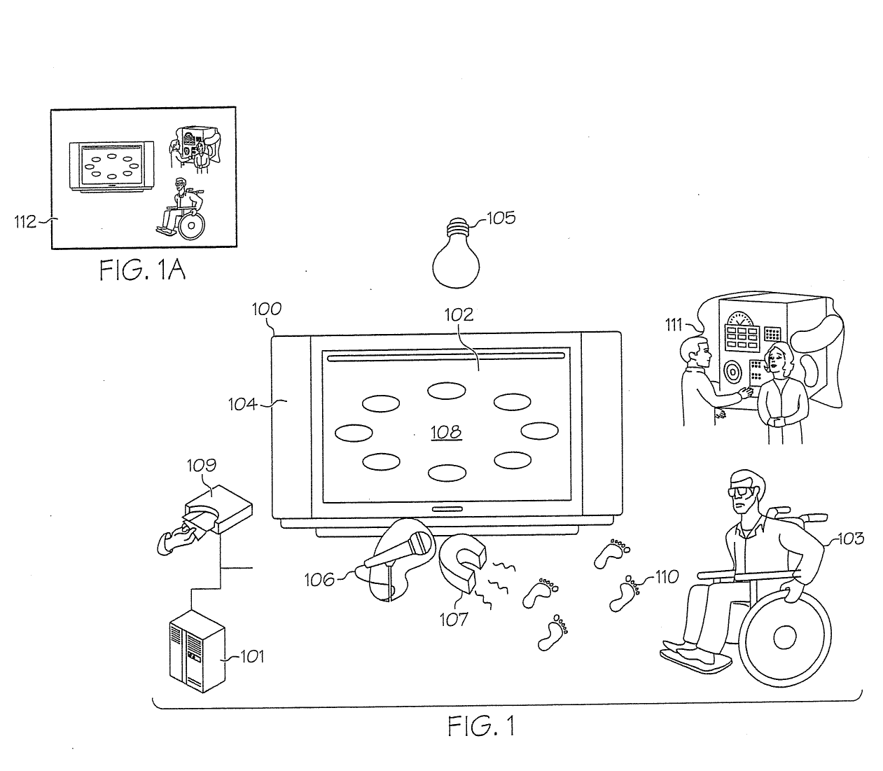

Referring to FIG. 1 there is shown a diagram of a physical presentation environment including features of the present invention, such as an interactive touch panel display, and items of support and enhancement for operation in a virtual space and the nearby physical spaces. Main display 100 provides a graphical rendition of the user's 103 primary interaction modality. The user 103 is at least one individual that may have limited access to all parts of the display. It will be appreciated that the display 100 may be any suitable size and may be scaled to a larger size and may also allow for user input via touch panel area 108. A computer system 101 provides for the display and touch panel area 108 which begins at a top level of presentation, consisting of a rotating cluster of sprites that are explained in subsequent description. One embodiment of the present invention provides the audio 104 and lighting 105 controls for all combinations of delivery channel for the user.

The lighting 105, under control from the central computer 101, may be used to illuminate other presentation in the physical environment. The output of the system described is not limited to computer monitor 102, sound 104 and lighting 105, as it can include control of mechanical and electronic devices, including other computer controlled system.

In addition, it will be appreciated that user input is not simply limited to touch panel 108 and similar conventional computer input devices such as keyboards and mouse. It may include interaction using sound input 106, proximity sensing system 107, and any other suitable electro/mechanical device (such as a business card reader 109), illuminated eye-catching means such as shadowed footprints 110 or physical delivery means 111.

It will also be appreciated that there may be a plurality of systems 10 interconnected as represented by FIG. 1A.

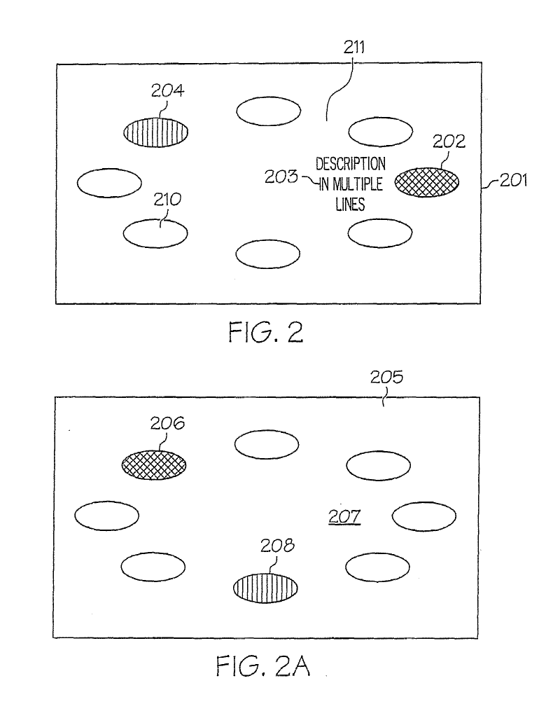

Referring also to FIGS. 2 and 2A, there is shown and embodiment of the virtual space presentation, as two separate intervals, 201 and 205 of the rotation of the field of selectable sprites 210 as a rotating cluster 211 of sprites 210. Each sprite 210 is normally available when the sprite is in a suitable position, as an example, 202 for subsequent activation via the use of a pointing device, such as a touch panel 108 or mouse (not shown). In addition, the rotation of the cluster 211 may be controlled by the user. For example, the user may control the rotation direction and/or rotation velocity by positioning a pointer on the display.

Each sprite 210 is annotated with a description leading to its meaning and may be displayed within the sprite 210 or by its rendition as a picture, as a text or a composite text/image. Additionally, a sprite may be annotated in the field of the display 203 when it enters certain zones during the rotation. As the cluster of sprites rotates, sprites occupy advancing positions, such as a depicted by sprite 202 in FIG. 2 rotating eventually to position 206 in FIG. 2A; and similarly as sprite 204 in FIG. 2 advances to sprite position 208 in FIG. 2A. Over time, the sprites continue a rotation process, repeating prior positions. At certain positions, the informational annotation field, populated and visible at position 203 may appear for only a narrow angle of rotation, and subsequently may not be displayed 207 until meeting the required angle of proximity.

It will be appreciated that the invention is not limited to the number of sprites and the presentation at some level of context to a singular cluster. It is intended that persons who cannot reach areas of the display will have opportunity to interact once the desired sprite comes within reach. It will also be appreciated that reach may be any suitable means for the user 103 to interact with or interrogate the desired sprite 210.

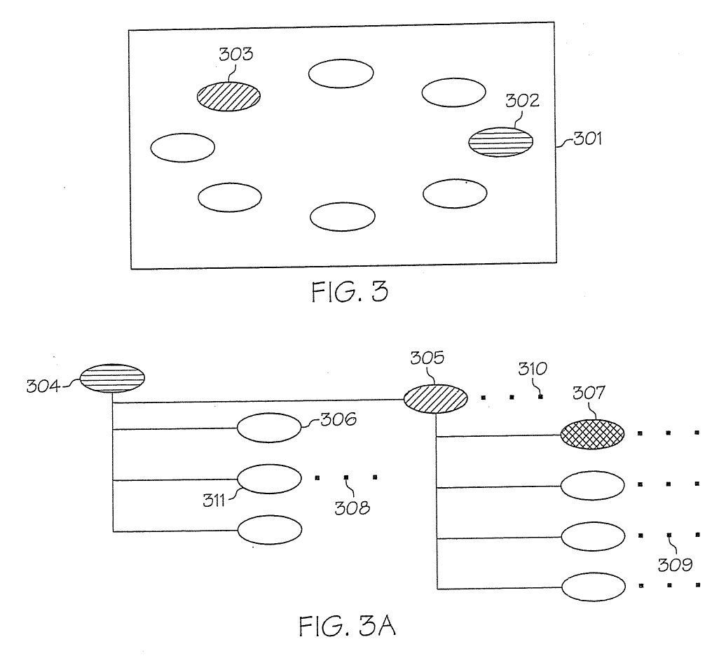

FIGS. 3 and 3A depict the information content hierarchy as it relates to that organization, shown as a connected tree graph that is associated with sprites 210. Each tree node is an object containing a name and associated information needed for invocation by the user selecting the sprite 210. In the virtual view 301 a selectable sprite 302 is associated with a tree graph of objects 304. Invoking object 304 results in a new orbital presentation; in this case, shown as three sprites. The first 306 and third which have no branching, indicative of invoking a viewer or other software in the virtual environment. Invocation of such can be a plurality of functions such as playing media and controlling external system.

The second sprite 311 may provide a menu of another orbital presentation 308 and thus, the tree hierarchy can go as deeply as desired. Likewise, sprite 305 is a sibling of 303 as they are presented in the same group on the display 301. The remaining siblings 310 are omitted for clarity. Sprite 307's children all represent groups of their own with dependent children 309. In summary the invocation of sprite 306 invokes a choice of actions depending on the specification, such as invoking a presentation choice, such as media (sound, movie), special programs, and system in the physical realm of the present invention.

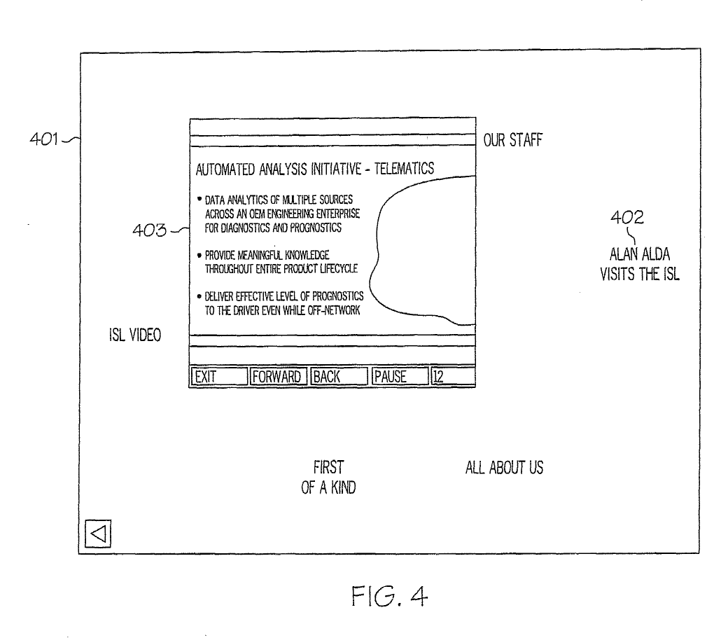

FIG. 4 illustrates the virtual environment of 401, the result of a user activation of a selection 402 that launches a presentation slide show 403 on the display.

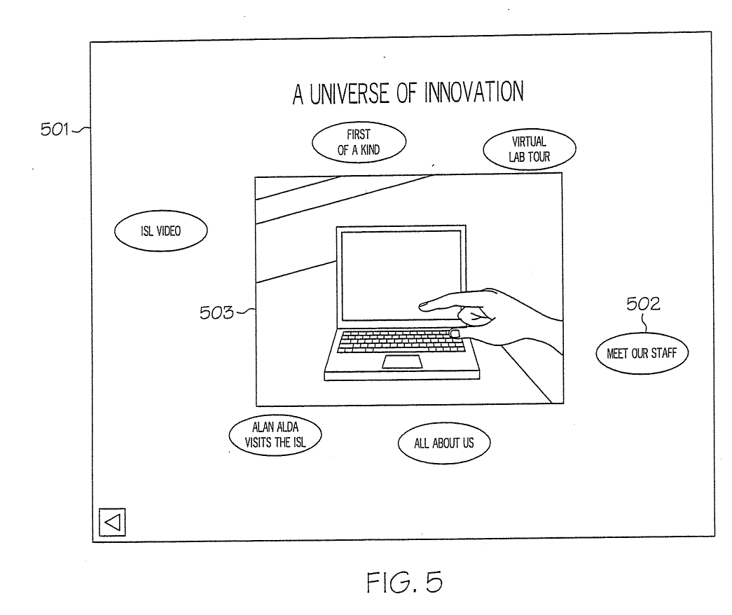

Similarly, FIG. 5 illustrates in the virtual environment of 501, the result of a typical user activation of selection 502 that launches a movie clip 503 on the display. It will be appreciated that any suitable number of simultaneous and combined actions may arise from a single sprite activation.

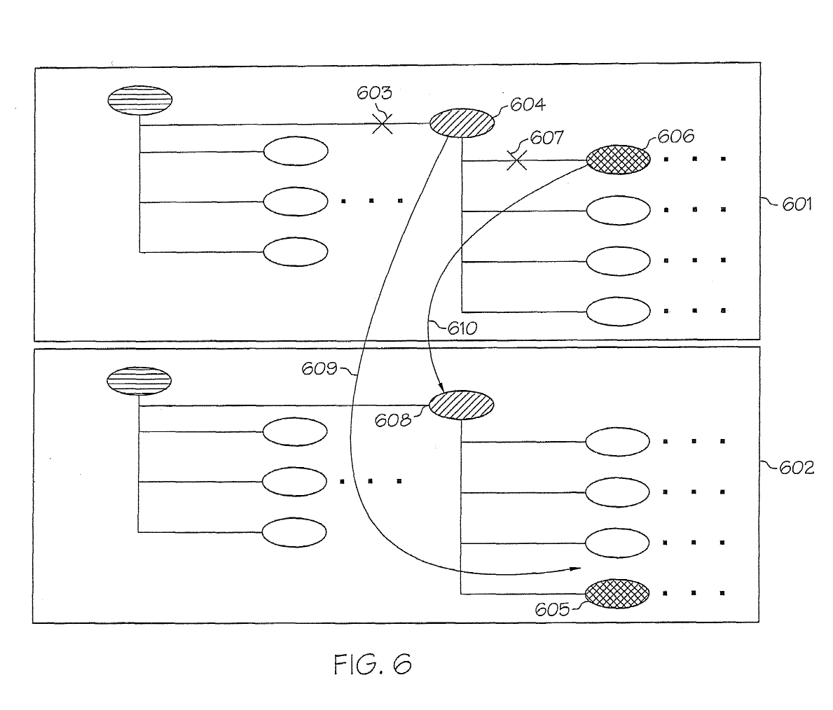

FIG. 6 shows the alteration of the virtual content due to feedback in the virtual or physical environments. The feedback may arise from a plurality of possible inputs including sprite activation and means via the physical environment such as sound and gadgetry, such as a business card reader 109 (see FIG. 1) that provides information about the user.

Consequently, a dynamic change can be formulated as illustrated in the before tree 601 that is changed 603 to a suitable after tree 602. The change allows the user to discover selection 606 more readily because it is promoted to a higher location of discovery 608. At the same time, a less likely candidate for selection 604 could be relegated 607 to a lower, less likely position 605. These are example of possible changes to the selectable navigation. The invention is not restricted to the number of changes and it is not necessary to maintain accessibility of any sprite in reformulations that may occur.

If user interactions cease for a period of time, or there is discoverability that there is no user in proximity 107, the system may automatically stop sprite-launched activities; and revert to display of parent sprite groupings. This process continues until the top level of the hierarchy is reached. Launched activities can also be stopped by normal ending or by specified timeouts that are associated with the sprite object. Elements in the physical environment, including the display itself can also be placed into a dormant state as a consequence of specified timeout, schedule or lack of user stimulus.

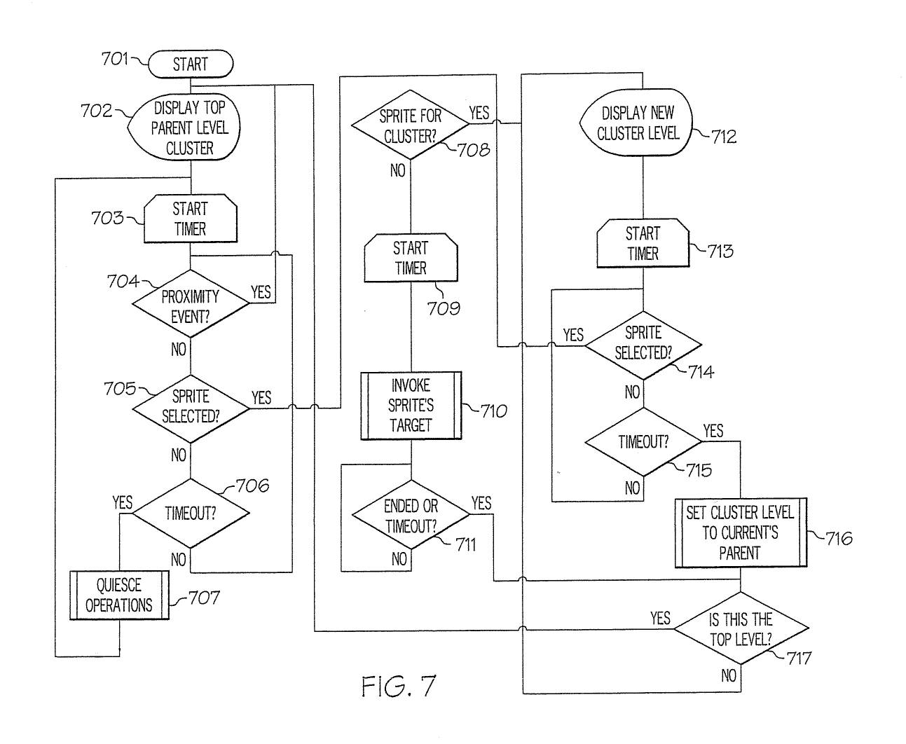

Refer also to FIG. 7 which depicts the logical operation of the virtual environment. The computer system 101 operates software that manages the display 100, beginning at 701. After placing the rotating top level cluster 702 the program starts a timer 703 and subsequently awaits a proximity event 704, a sprite event 705, or a timeout event 706. The invention is not limited to only these three events as it may be that other external signaling or sensing could introduce additional tests. The loop depicted here is only for illustration of the means for managing such events. If no event occurs, ultimately a timeout will occur 706 and operations are scaled down 707. For example, the display may be dimmed, gadgets idled, and illumination and generated sound may be profoundly lowered for this idle period. In such case, a new timer process is initiated 703 and again the process of discovery continues. If a proximity event occurs 704, the system is placed back into a non-idle state, thus display brightened and the physical environment is adjusted to initial conditions to attract users for sprite selection, also, the timer loop is re-entered 703.

Once a sprite is selected 705 software determines whether the sprite represents yet another child cluster or something that can be launched into activity 708. If it is another cluster, the new child cluster level is invoked 712 and a new timer loop is entered 713.

It will be appreciated that the invention is not limited as to the duration times assigned to timers or the requirement for identical timer mechanisms. For example, each sprite object may contain custom information regarding timeouts which can be adjusted. Two general events, sprite selection 714 and timeout 715 are expected during the loop. It will also be appreciated that the invention is not limited by the modality implied by the FIG. 7 tight timer loops; other operations or simultaneous operations as depicted in this figure may be concurrent.

If a timeout occurs 715, the system will leave the lower level cluster by selecting the parent level of the timed-out cluster 716. If this results in achieving the top level 717 the process reverts to the startup scenario 702. If this results in an intermediate cluster level then that cluster level is instantiated 712 and the process continues. If the sprite selected 705 or 714 is determined to be not a cluster 708, then the processing continues using the metadata associated with said sprite to show media or invoke whatever processing might be constructed for that selected sprite.

Just before invoking the selected sprite, a timer 709 is started to insure cancellation of the process as the user could simply walk away leaving the system in an awkward state. After timer initialization, the target action is invoked 710 and the logical operation awaits its ending or occurrence of the timeout 711.

The display of the cluster either continues or is continued by resumption of the flow of the logical operation at either 702 or 712 depending on the level previously shown. The invention is not limited to a modality wherein the launch of a target process for a sprite subsumes the display of the current cluster. The logical operation can consist of simultaneous display of the cluster and the target invocation of the sprite. The logical operation is not limited to any mandate that only one sprite may be selected at a time. Normal disjuncture of the logical operation as shown in FIG. 7 can allow additional launchings with multiple timeout conditions being maintained.

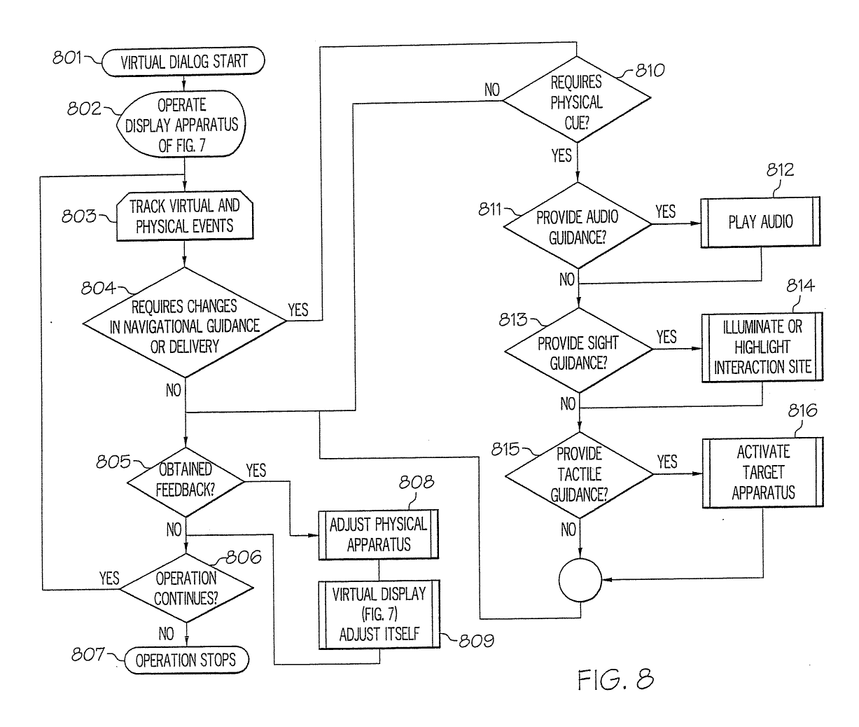

Refer also to FIG. 8 which depicts the multi-modal fusion of the delivery of information. Given any beginning state in the virtual space 801 content is first delivered using a display 802. During the operation of that system as described in FIG. 7 the running virtual system can provide event notifications 803. As these events occur, it is determined 804 if an instantiation or modification to the navigational guidance is required based upon predetermined criteria.

If the virtual system, on the other hand, requires feedback from the physical space 805, the physical system is either adjusted or informed that it may adjust itself 808 appropriately. Likewise, for the purpose of synchronizing the physical with the virtual, the virtual display can adjust itself 809. At any moment in this multi-modal operation there is a synchronous moment when operations can be safely stopped 807, tested by the system at 806.

If guidance is to be provided in the physical space 810, then the designed cue, appropriate to the needs is discovered 811, 813 and 815; and appropriately enacted, correspondingly 812, 814 and 816. The invention is not limited to a specific type of sensory channel as depicted in FIG. 8. It applies to any stimulus affecting the sensory capability of the subject user. The sequences of FIG. 8 do not include the notion of timeouts and proximity checks as detailed in FIG. 7, but these applications apply equally throughout FIG. 8 as is suitable.

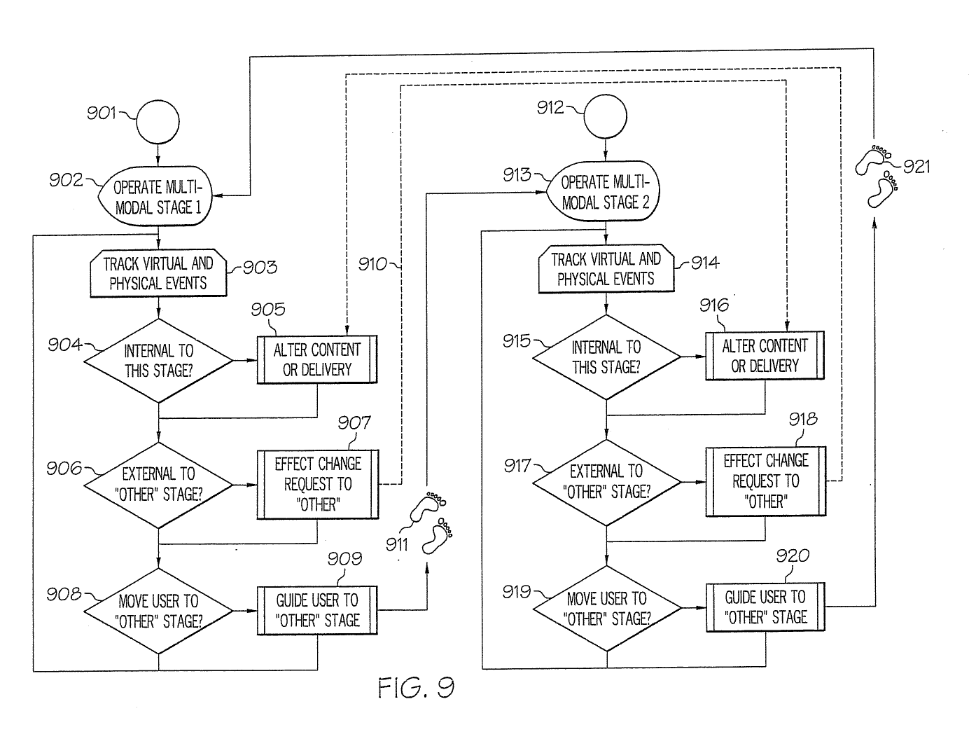

Referring also to FIG. 9, there is shown the in-context assembly of independent displays in physical spaces. Each of the interactive display systems begins 902, 913, from a starting state 901, 912, wherein all system behavior is default. For our example, the starting point 901 corresponds to a display stage, called stage 1. Likewise, the starting point 912 corresponds to the display stage 2.

Given a first user visitation to stage 1, as a user interacts with the stage 903, various adjustments are made to the modality of the virtual and physical articles as previously described for FIGS. 7 and 8. In this manner, locally discovered user needs are identified 904 and are applied 905. If the user interaction is found to indicate desire to eventually 906 move the user to at least one other “stage”, the system can tally stage changes needed to the other stage 907 and pass them concurrently with guiding the user's move or in advance of an anticipated move. The invention is not limited to the exact timing or bundling of the information as any suitable means may be used to provide the information “in time” for ultimate consumption by the moved user. Ultimately, the stage can decide 908 to entice the user to move 909. The method for moving can be any means described virtually (display) or physically by exploiting some sensory means such as a lighted pathway 911. It will be appreciated that any suitable sensory means may be used, such as, for example, audio sounders such as beepers, may be used to guide the user to the other or second stage. It will also be appreciated that any other suitable means to provide guidance and direction to the user for navigation in physical and virtual space using motion detection, proximity, and sensory inputs of the user including sight, sound, touch, smell and taste from one such space to another space may be used.

Once moved, the user will find that the new stage has had customization instantiated in a manner similar to the user's old stage customization and therefore appealing to the user. As with stage 1, the event tracking 914 and modification of iterative actionable insights and modalities 915, 916, 917 and 919 can be continued in a progressive manner. This can lead to guiding the user back 920, 921 to the earlier stage, appropriately re-adjusted 918 to newly acquired insights. This can lead to a continuation of interaction possibilities of another stage and eventually the termination of user interactions. The multi-modal processes of each said stage 902, 913 can revert to default after factors of a change in environment occur. These can include timeout(s), loss of subject (user) detection and “system resets”.

One embodiment claims the in-context assembly of the aforementioned independent displays that are in proximity to each other in a physical space with described means to guide a tracked user from one independent display to at least on other independent display, continuing the information delivery in manner or mode that was deemed appropriate for the user prior to the guided move.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for multi-modal fusion of a physical information channel and a virtual information channel, the method comprising:
providing at least one virtual information channel;
providing at least one physical information channel;
providing virtual space content;
tracking at least one virtual event;
tracking at least one physical event corresponding to the at least one virtual event; and
altering delivery of the virtual space content upon determining the tracked at least one virtual event meets predetermined criteria.

2. The method as in claim 1 wherein altering delivery of the virtual space content further comprises altering delivery of the virtual space content upon determining the tracked at least one physical event meets predetermined criteria.

3. The method as in claim 1 further comprising altering navigational guidance upon determining the tracked at least one virtual event meets predetermined criteria.

4. The method as in claim 3 further comprising altering navigational guidance upon determining the tracked at least one physical event meets predetermined criteria.

5. The method as in claim 4 wherein altering navigational guidance further comprises providing audio guidance via the at least one physical information channel.

6. The method as in claim 4 wherein altering navigational guidance further comprises providing visual guidance via the at least one physical information channel.

7. The method as in claim 4 wherein altering navigational guidance further comprises providing tactile guidance via the at least one physical information channel.

8. The method as in claim 1 further comprising:
determining if the at least one virtual information channel requires predetermined feedback information from the at least one virtual information channel;
receiving the predetermined feedback information; and
adjusting the at least one physical information channel based upon the received feedback information.

9. A multi-modal system for multi-modal fusion of physical information and a virtual information channel, the multi-modal system comprising:
a reconfigurable virtual display for displaying the virtual information;
at least one input device connectable to the processor for receiving the physical information;
at least one output device for providing output physical information, connectable to the processor; and
a processor connected to the reconfigurable display wherein the processor is adaptable to tracking physical and corresponding virtual events and reconfiguring the reconfigurable virtual display according to the physical information and altering the output physical information provided by the at least one output device.

10. The multi-modal system as in claim 9, wherein the at least one input device connectable to the processor comprises at least one sensory input device.

11. The multi-modal system as in claim 9, wherein the at least one input device connectable to the processor comprises at least one magnetic input device.

12. The multi-modal system as in claim 9, wherein the at least one input device connectable to the processor comprises at least one optical input device.

13. The multi-modal system as in claim 9, wherein the at least one output device comprises at least one sensory output device.

14. A program storage device readable by a machine, tangibly embodying a program of instructions executable by the machine to perform a method for multi-modal fusion of a physical information channel and a virtual information channel, the method comprising:
providing at least one virtual information channel;
providing at least one physical information channel;
providing virtual space content;
tracking at least one virtual event;
tracking at least one physical event corresponding to the at least one virtual event;
altering delivery of the virtual space content upon determining the tracked at least one virtual event meets predetermined criteria, wherein altering delivery of the virtual space content further comprises:
altering delivery of the virtual space content upon determining the tracked at least one physical event meets predetermined criteria;
altering navigational guidance upon determining the tracked at least one virtual event meets predetermined criteria;
altering navigational guidance upon determining the tracked at least one physical event meets predetermined criteria, wherein altering navigational guidance further comprises providing navigational guidance selected from the group consisting of
providing audio guidance via the at least one physical information channel,
providing visual guidance via the at least one physical information channel, and
providing tactile guidance via the at least one physical information channel;
determining if the at least one virtual information channel requires predetermined feedback information from the at least one virtual information channel;
receiving the predetermined feedback information; and
adjusting the at least one physical information channel based upon the received feedback information.
